(19) United States
(12) Patent Application Publication
(10) Pub. No.: US 2025/0140460 A1
(43) Pub. Date: May 1, 2025

(54) MAGNETICALLY COUPLED INDUCTOR AND METHOD OF ASSEMBLING THE SAME

(71) Applicant: SUMIDA CORPORATION, Tokyo (JP)

(72) Inventor: Takanari FUJIMAKI, Miyagi (JP)

(73) Assignee: SUMIDA CORPORATION, Tokyo (JP)

(21) Appl. No.: 18/834,911

(22) PCT Filed: Mar. 29, 2022
(86) PCT No.: PCT/JP2022/015627

§ 371 Date: Jul. 31, 2024

(51) Int. Cl. H01F 3/10; H01F 5/02; H01F 17/04; H01F 27/34; H01F 38/14; H01F 41/098

(52) U.S. Cl. CPC H01F 3/10; H01F 5/02; H01F 17/04; H01F 27/346; H01F 38/14; H01F 41/098

(57) ABSTRACT

An annular-shaped spacer member is attached in a split manner in a circumferential direction of a winding shaft portion of a bobbin through which middle leg portions are inserted. The spacer member includes: a cylindrical portion on which an annular third core is placed; and flange portions provided at both ends thereof. The third core is split in the circumferential direction and mounted on the outer circumferential portion of the cylindrical portion of the spacer member in a state in which, of elements of the shape of the third core and the material characteristic of the third core, the magnitude of at least one of the elements is set so that a desired leakage inductance value is generated.

### TECHNICAL FIELD

The present invention relates to a magnetically coupled inductor that is mounted on an electronic circuit or the like for various devices and a method of assembling the same.

### BACKGROUND ART

According to a magnetically coupled inductor, it is possible to reduce ripple by causing two incorporated inductors to operate in an interleaved manner, to improve a DC superimposition characteristic through offset of DC magnetic fluxes generated inside a core, and as a result, to achieve size reduction and an increase in efficiency of the coupled inductor and further a decrease in size of a capacitor.

As a magnetically coupled inductor in the related art, a magnetically coupled inductor with a configuration in which a ring-shaped third core 102 is sandwiched between flange portions 112 and 112′ of two split bobbins 110 and 110′ into which intermediate leg portions of a first core 101 and a second core 101′ are inserted as described in Patent Literature 1 (FIG. 1, in particular) below is known. Note that the split bobbins 110 and 110′ are provided with winding shaft portions 111 and 111′ around which coil windings are wound, respectively.

### CITATION LIST

### Patent Literature

Patent Literature 1: Japanese Patent Publication No. 4-014487

### SUMMARY OF INVENTION

### Technical Problem

However, since the aforementioned related art is configured such that the third core 102 is sandwiched between the two split bobbins 110 and 110′, it is difficult to secure dimensional accuracy of an interval between two terminal arrays 115 and 115′ projecting from bottom portions of the bobbins 110 and 110′ and attached to a substrate and rigidity of the bobbins 110 and 110′. Also, since the related art is limited to an aspect in which the shape (the thickness, for example) of the third core 102 is also set in advance, it is difficult to make adjustment to a leakage inductance value depending on a situation.

The present invention was made in view of the above circumstances, and an object thereof is to provide a magnetically coupled inductor that causes two incorporated inductors to operate in an interleaved manner, facilitates adjustment to a leakage inductance value depending on a situation, and facilitates securing of dimensional accuracy of an interval between terminal pins of terminal blocks and rigidity of winding shaft portions of bobbins at the time of the adjustment, and a method of assembling the magnetically coupled inductor.

### Solution to Problem

A magnetically coupled inductor according to the present invention comprises:
a first magnetic core and a second magnetic core, each of which includes an intermediate leg portion, outer leg portions located on both sides of the intermediate leg portion, and a rear surface portion that connects the intermediate leg portion and the outer leg portions, the first magnetic core and the second magnetic core being disposed such that distal ends of the intermediate leg portions and distal ends of the outer leg portions are made to abut each other;
a bobbin, into which the intermediate leg portions of the first magnetic core and the second magnetic core are inserted, the bobbin being disposed outside the intermediate leg portions of the two magnetic cores;
an annular-shaped spacer member that is attached in a split manner in a circumferential direction of a winding shaft portion of the bobbin into which the intermediate leg portions are inserted, the annular-shaped spacer member being configured of a cylindrical portion on which an annular-shaped third magnetic core is placed and flange portions disposed at both ends of the cylindrical portion; and
a first coil winding that is wound around one of regions of the winding shaft portion in the axial direction split by the spacer member and a second coil winding that is wound around the other region,
wherein the third magnetic core is attached to an outer periphery of the cylindrical portion of the spacer member in a split manner in the circumferential direction in a state where at least one element from among a shape of the third magnetic core and a material characteristic of the third magnetic core is set to a predetermined size to lead to a desired leakage inductance value depending on a positional relationship between the first magnetic core and the second magnetic core.

The at least one element is preferable to be a thickness of the third magnetic core.

In the above case, a width of the cylindrical portion of the spacer member is preferable to be adjusted to a size depending on the thickness of the third magnetic core.

Further, the at least one element is preferable to be an inner diameter of the third magnetic core.

In the above case, an outer diameter of the cylindrical portion of the spacer member is preferable to be adjusted to a size depending on the inner diameter of the third magnetic core.

Further, the at least one element is preferable to be an outer diameter of the third magnetic core.

In addition, the at least one element is preferable to be a magnetic saturation characteristic of the third magnetic core.

Further, the spacer member is preferable to be attached to the winding shaft portion by mutually engaging a plurality of first engagement portions aligned in the circumferential direction of an outer circumferential surface of the winding shaft portion and second engagement portions aligned in the circumferential direction of an inner circumferential surface of the cylindrical portion to correspond to the first engagement portions.

It is preferable that at least one second engagement portion is provided for each spacer member split in the circumferential direction to correspond to a plurality of first engagement portions aligned in the circumferential direction of an outer circumferential surface of the winding shaft portion.

Further, it is preferable to comprise spacer assembly engagement portions with which each spacer member split in the circumferential direction is engaged and integrated with each other in a state where the spacer member is attached to the winding shaft portion.

Further, it is preferable that outermost circumferential portions of flange portions disposed at both ends of the winding shaft portion of the bobbin are configured to have heights with which the outermost circumferential portions are in a vicinity of outermost circumferential portions disposed at both ends of the cylindrical portion of the spacer member.

A method of assembling a magnetically coupled inductor according to the present invention comprises:
a first process of
   causing distal end portions of intermediate leg portions and distal ends of corresponding outer leg portions of a first magnetic core and a second magnetic core to abut each other, each of the first magnetic core and the second magnetic core including the intermediate leg portion, the outer leg portion located on both sides of the intermediate leg portion, and a rear surface portion connecting the intermediate leg portion and the outer leg portions,
   inserting the intermediate leg portions of the first magnetic core and the second magnetic core into a hollow portion of a bobbin, and
   attaching an annular-shaped spacer member that is split in a circumferential direction of a winding shaft portion of the bobbin, into which the intermediate leg portion is inserted, in the circumferential direction, the annular-shaped spacer member including a cylindrical portion on which an annular-shaped third magnetic core is placed and flange portions disposed at both ends of the cylindrical portion;
   a second process of winding a first coil winding in one of regions split in an axial direction of the winding shaft portion by the spacer member and winding a second coil winding in the other region; and
a third process of
   setting at least one element from among elements such as a shape of a third magnetic core and a material characteristic of the third magnetic core to a predetermined size to enable a leakage inductance value of the third magnetic core to be set to a desired value, and
   attaching the third magnetic core in which the at least one element has been set to the predetermined size to an outer periphery of the cylindrical portion of the spacer member in a split manner in the circumferential direction,
   the second process and the third process being performed in a predetermined order after the first process.

### Advantageous Effects of Invention

The magnetically coupled inductor according to the present invention is configured such that an annular-shaped third magnetic core can be placed on a spacer member attached to a winding shaft portion of a bobbin in a state where adjustment has been made to achieve a desired leakage inductance value by selecting at least one element from among elements such as the shape of the third magnetic core and a material characteristic of the third magnetic core. This facilitates adjustment of a leakage inductance value of the magnetically coupled inductor and also facilitates securing of dimensional accuracy of the interval between the terminal pins of the terminal blocks and rigidity of the winding shaft portion of the bobbin since the length and the rigidity of the winding shaft portion of the bobbin do not change through the adjustment.

### BRIEF DESCRIPTION OF DRAWINGS

FIG. 1A is a perspective view illustrating a magnetically coupled inductor according to an embodiment of the present invention (FIG. 1A illustrates a state where a bobbin and a spacer member have been removed).

FIG. 1B is a perspective view illustrating a magnetically coupled inductor according to an embodiment of the present invention (FIG. 1B illustrates a state where a bobbin, a spacer member, and coil windings have been removed).

FIG. 2 is a perspective view illustrating the magnetically coupled inductor according to the embodiment of the present invention (a state where the coil windings have been removed).

FIG. 3 is a schematic sectional view illustrating a flow of a magnetic flux of the magnetically coupled inductor according to the embodiment of the present invention.

FIG. 4A is a schematic view illustrating an aspect in which a leakage inductance value is adjusted in the magnetically coupled inductor according to the embodiment of the present invention (FIG. 4A illustrates an aspect in which the thicknesses of the spacer member and a ring core are changed).

FIG. 4B is a schematic view illustrating an aspect in which a leakage inductance value is adjusted in the magnetically coupled inductor according to the embodiment of the present invention (FIG. 4B illustrates an aspect in which the outer diameter of a center groove portion of the spacer member and the inner diameter of the ring core are changed).

FIG. 4C is a schematic view illustrating an aspect in which a leakage inductance value is adjusted in the magnetically coupled inductor according to the embodiment of the present invention (FIG. 4C illustrates an aspect in which the outer diameter of the ring core is changed).

FIG. 4D is a schematic view illustrating an aspect in which a leakage inductance value is adjusted in the magnetically coupled inductor according to the embodiment of the present invention (FIG. 4D illustrates an aspect in which a magnetic saturation characteristic of the ring core is changed).

FIG. 5A is a perspective view illustrating an assembly process 1A of the magnetically coupled inductor according to the embodiment of the present invention.

FIG. 5B is a perspective view illustrating an assembly process 1B of the magnetically coupled inductor according to the embodiment of the present invention.

FIG. 6A is a perspective view illustrating an assembly process 2A of the magnetically coupled inductor according to the embodiment of the present invention.

FIG. 6B is a perspective view illustrating an assembly process 2B of the magnetically coupled inductor according to the embodiment of the present invention.

FIG. 7A is a perspective view illustrating an assembly process 3A of the magnetically coupled inductor according to the embodiment of the present invention.

FIG. 7B is a perspective view illustrating an assembly process 3B of the magnetically coupled inductor according to the embodiment of the present invention.

FIG. 8 is a perspective view illustrating an assembly process 4 of the magnetically coupled inductor according to the embodiment of the present invention.

FIG. 9A is a perspective view illustrating a spacer member of the magnetically coupled inductor according to the embodiment of the present invention (FIG. 9A illustrates a state where the spacer member is integrated).

FIG. 9B is a perspective view illustrating a spacer member of the magnetically coupled inductor according to the embodiment of the present invention (FIG. 9B illustrates a state where the spacer is disassembled into two parts).

FIG. 10 is a schematic view for explaining a related art.

### DESCRIPTION OF EMBODIMENT

Hereinafter, a magnetically coupled inductor and a method of assembling the magnetically coupled inductor according to an embodiment of the present invention will be described on the basis of the drawings.

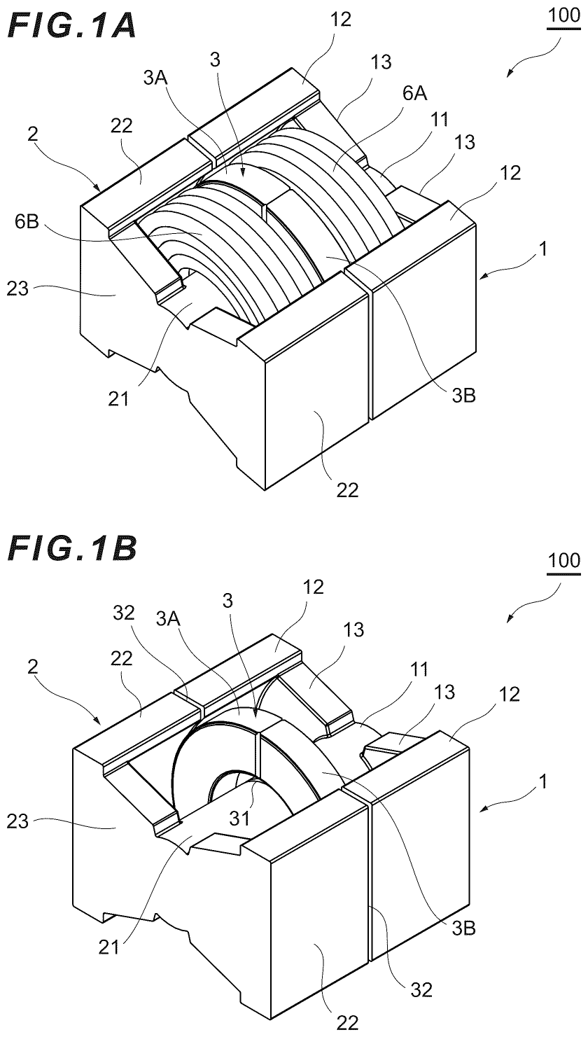

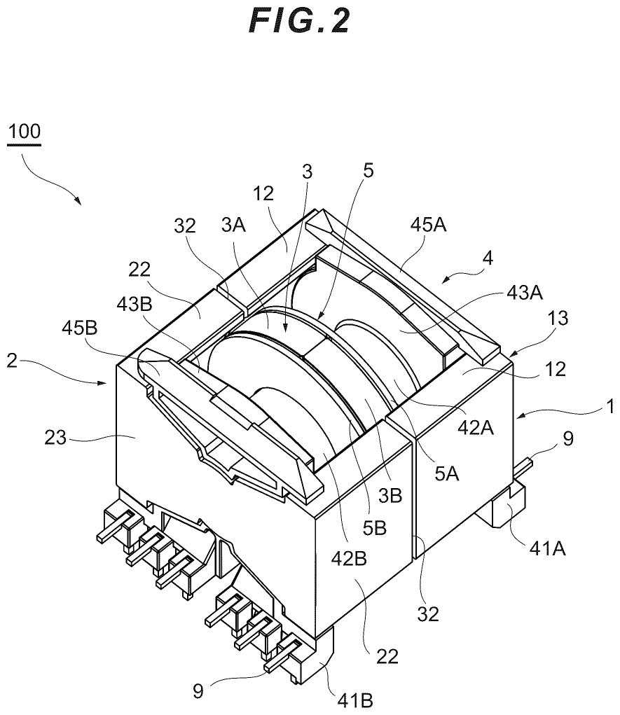

FIG. 1A is a perspective view of a magnetically coupled inductor 100 according to the embodiment in a state where a bobbin and a spacer member have been removed, FIG. 1B is a perspective view of the magnetically coupled inductor 100 according to the embodiment in a state where the bobbin, the spacer member, and coil windings have been removed, and FIG. 2 is a perspective view of the magnetically coupled inductor 100 according to the embodiment in a state where the coil windings have been removed.

The magnetically coupled inductor 100 in the embodiment includes, as main elements, a first core 1 and a second core 2, each of which is a PQ core, a third core 3 (3A, 3B) configured of a ring core (annular core), a first coil winding 6A, and a second coil winding 6B as illustrated in FIGS. 1A and 1B.

The first core 1 and the second core 2 are made of, for example, ferrite cores and include intermediate leg portions 11 and 21, each of which has a columnar shape, outer leg portions 12, 12, 22, 22 disposed at both side portions of the intermediate leg portions 11 and 21, and rear surface portions 13 and 23 that connect the intermediate leg portions 11 and 21 to the outer leg portions 12, 12, 22, and 22, respectively, and the first core 1 and the second core 2 are disposed to face each other to form symmetrical shapes.

The length of the intermediate leg portions 11 and 21 is about ½ the distance of the interval between the facing rear surface portions 13 and 23, and the outer leg portions 12, 12, 22, and 22 have plate shapes with arc-shaped inner side surfaces and flat surface-shaped outer side surfaces.

Also, corresponding distal ends of the three leg portions 11, 12, and 12 configuring the first core 1 and the three leg portions 21, 22, and 22 configuring the second core 2 are disposed to face each other via gaps 31, 32, and 32, which are minute intervals.

In addition, the third core 3 is made of, for example, a ferrite core and has an annular shape with a rectangular section. Moreover, the third core 3 is made of a combination of a pair of semiannular-shaped ring core members (semiannular-shaped ring cores) 3A and 3B.

FIG. 2 illustrates a state where a bobbin 4 and a spacer member 5, which are not illustrated in FIG. 1B, the first core 1, the second core 2, and the third core 3 are combined. However, a state where the coil windings 6A and 6B have been removed to show the inside of the bobbin 4 is illustrated.

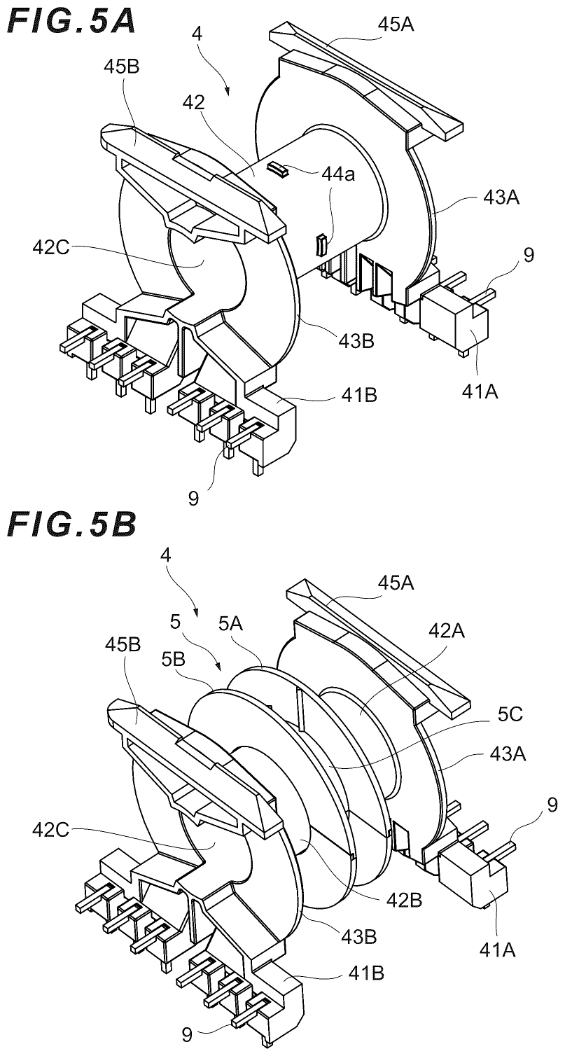

The bobbin 4 is made of an insulating resin, includes flange portions 43A and 43B at both ends of a cylindrical-shaped winding shaft portion 42, and includes terminal blocks 41A and 41B below the flange portions 43A and 43B, respectively, as illustrated in FIG. 5A. The terminal blocks 41A and 41B are provided with a plurality of terminal pins 9 and 9, respectively.

Also, the intermediate leg portion 11 of the first core 1 is inserted from one end side of a hollow portion 42C and the intermediate leg portion 21 of the second core 2 is inserted from the other end side into the tubular-shaped winding shaft portion 42 of the bobbin 4, and a mode in which the bobbin 4 is disposed outside each of the intermediate leg portions 11 and 21 is obtained.

Also, the corresponding intermediate leg portions 11 and 21 and outer leg portions 12, 12, 22, and 22 on both sides of the first core 1 and the second core 2 are made to abut each other, and the gaps 31, 32, and 32 are provided between the corresponding leg portions (see FIG. 1B.

On the other hand, a plurality of (four at every 90 degrees, for example) engagement protrusions 44a are provided in a circumferential direction of an outer circumferential surface of the winding shaft portion 42 of the bobbin 4 at substantially center positions in an axial direction of the outer circumferential surface as illustrated in FIG. 5A, and a spacer member 5 is attached at the position. The spacer member 5 includes a ring core placement groove portion 5C on which the third core 3 is placed between both spacer flange portions 5A and 5B, and the ring core placement groove portion 5C has an inner diameter that allows fitting along the outer circumferential surface of the winding shaft portion 42 of the bobbin 4.

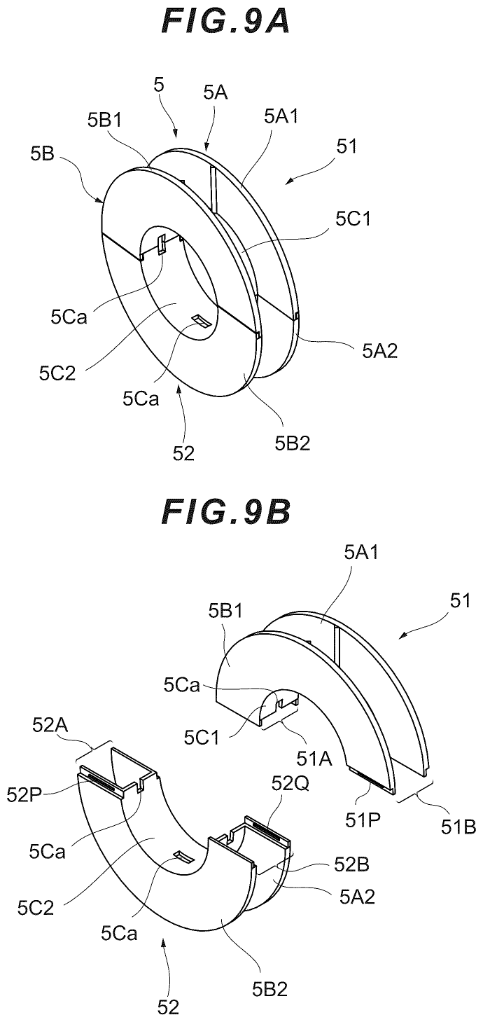

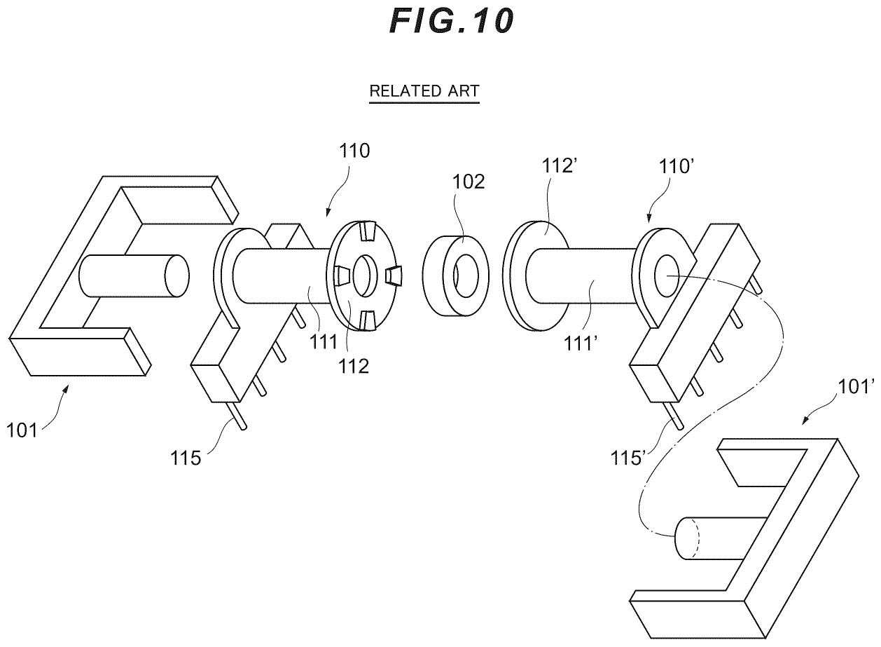

Also, the ring core placement groove portion 5C is provided with engagement holes 5Ca to be engaged with engagement protrusions 44a installed on the outer circumferential surface of the winding shaft portion 42 such that the number of the engagement holes 5Ca is the same as the number of installed engagement protrusions 44a (see FIGS. 9A and 9B).

Note that the cylindrical-shaped spacer member 5 is configured of two semiannular portions 51 and 52 as illustrated in FIG. 9B to allow attachment to the winding shaft portion 42 and is configured such that the two semiannular portions 51 and 52 are engaged and integrated with each other when each engagement hole 5Ca is engaged with the corresponding engagement protrusion 44a and the two semiannular portions 51 and 52 are attached to the winding shaft portion 42. A configuration that contributes to the engagement of the two semiannular portions 51 and 52 will be described later.

Note that as described above, each engagement protrusion 44a is provided at substantially the center position in the axial direction of the outer circumferential surface of the winding shaft portion 42 as described above, while each engagement hole 5Ca is also provided at substantially the center position in the axial direction of the ring core placement groove portion 5C. Therefore, a state in which winding shaft regions 42A and 42B of the winding shaft portion 42 have substantially the same area on both sides of the spacer member 5 in the axial direction in a state where the spacer member 5 is attached to the winding shaft portion 42 is provided. The first coil winding 6A is wound around the winding shaft region 42A which is one of the regions split by the spacer member 5, and the second coil winding 6B is wound around the other winding shaft region 42B.

Both terminals of the first coil winding 6A are connected to corresponding terminal pins 9 on the side of the terminal block 41A, and both terminals of the second coil winding 6B are connected to corresponding terminal pins 9 on the side of the terminal block 41B.

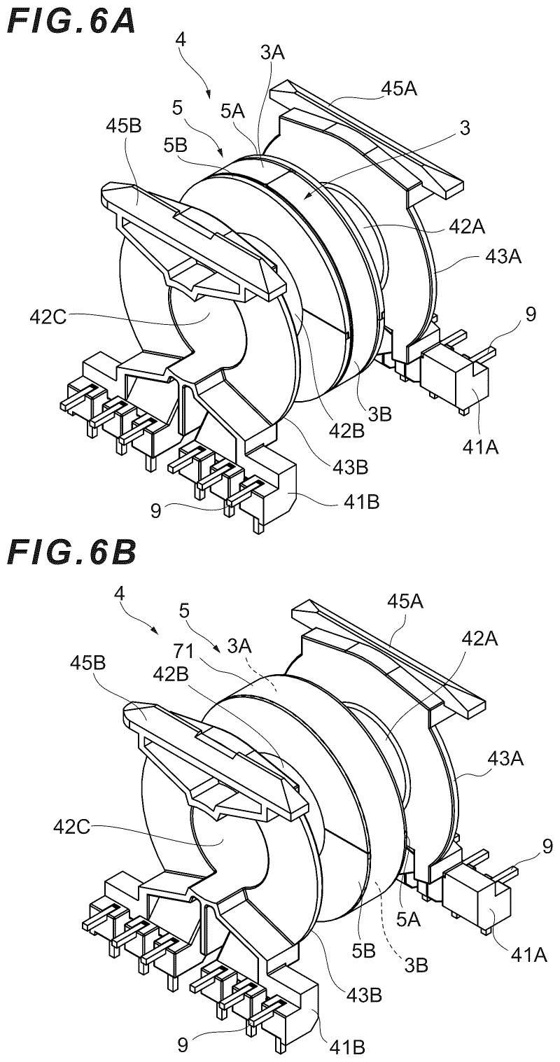

As illustrated in FIG. 2, semiannular-shaped ring cores 3A and 3B split into two semiannular shapes are attached to the ring core placement groove portion 5C of the spacer member 5, and the third core is disposed along the entire outer circumferential surface of the ring core placement groove portion 5C in the attached state. Note that in the state where the semiannular-shaped ring cores 3A and 3B are attached to the outer circumferential surface of the ring core placement groove portion 5C, a ring core fixation tape 71 is wound around the outer circumferential surfaces of the semiannular-shaped ring cores 3A and 3B to prevent the semiannular-shaped ring cores 3A and 3B from falling off (see FIG. 6B).

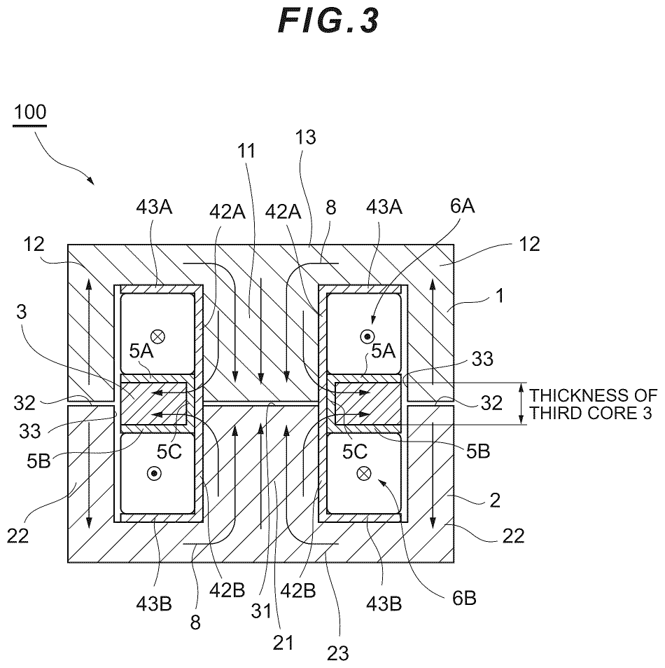

The magnetically coupled inductor 100 with a basic configuration as described above has a two-in-one (2 in 1) structure in which core portions are formed in the shape of two adjacent rectangles in plan view with the third core 3 that is an annular magnetic core sandwiched between the first core 1 and the second core 2. In this manner, magnetic fluxes 8 in the magnetically coupled inductor 100 with the core portions formed in the shape of two adjacent rectangles in plan view have flows as illustrated by the arrows in FIG. 3, and the magnetic fluxes 8 generated by currents that pass through the first coil winding 6A and the second coil winding 6B and passing through the third core 3 are in mutually the same direction.

More specifically, the gaps 31, 32, and 32 are formed between the intermediate leg portions 11 and 21 and the outer leg portions 12, 12, 22, and 22 of the first core 1 and the second core 2 as described above. Therefore, the magnetic fluxes 8 passing through the rear surface portion 13 from the outer leg portions 12 and 12 on both sides are merged at the intermediate leg portion 11 and flow toward the distal end surface of the intermediate leg portion 11 in the first core 1.

On the other hand, the magnetic fluxes passing through the rear surface portion 23 from the outer leg portions 22 and 22 on both side are merged at the intermediate leg portion 21 and flow toward the distal end surface of the intermediate leg portion 21 in the second core 2.

The magnetic fluxes 8 flowing through the two intermediate leg portions 11 and 21 collide against each other at the distal end surfaces of the intermediate leg portions 11 and 21 and are offset. On the other hand, the magnetic fluxes 8 branched in the direction of the third core 3 before the collision pass through the third core 3 and reach the outer leg portions 12, 12, 22, and 22 of the first core 1 and the second core 2.

As a result, a magnetic loop made of the magnetic fluxes 8 circulating in the arrow directions as illustrated in FIG. 3 is formed in the first core 1, the second core 2, and the third core 3.

Note that as illustrated in FIG. 3, a gap 33 of a predetermined interval is also formed between the third core 3 and the outer leg portions 12, 12, 22, and 22 of the first core 1 and the second core 2.

Incidentally, the core portions (the first core 1, the second core 2, and the third core 3) are formed in the shape of two adjacent rectangles in plan view as a whole as described above, and the proportion of the magnetic fluxes 8 branched in the direction of the third core 3 and flowing through the outer leg portions 12, 12, 22, and 22 of the first core 1 and the second core 2 from among the magnetic fluxes 8 flowing through the intermediate leg portions 11 and 21 of the first core 1 and the second core 2 can be adjusted by changing how easily the magnetic fluxes 8 flow from the intermediate leg portions 11 and 21 of the first core 1 and the second core 2 to the third core 3.

The magnetically coupled inductor in the embodiment is configured to be able to adjust how easily the magnetic fluxes 8 flow in the direction of the third core 3 from the intermediate leg portions 11 and 21 to a desired leakage inductance (leakage magnetic flux) value by focusing on the aforementioned point and exchanging (selecting) at least one element from among the thickness (width) of the third core 3 (ring core), the inner diameter of the third core 3 (ring core), the outer diameter of the third core 3 (ring core), and a magnetic saturation characteristic of the third core 3 (ring core). Note that in a case where the thickness of the third core 3 (ring core) is changed, it is desirable to change the width of the ring core placement groove portion 5C of the spacer member 5 according to the change. Also, in a case where the inner diameter of the third core 3 (ring core) is changed, it is desirable to change the outer diameter of the ring core placement groove portion 5C of the spacer member 5 according to the change.

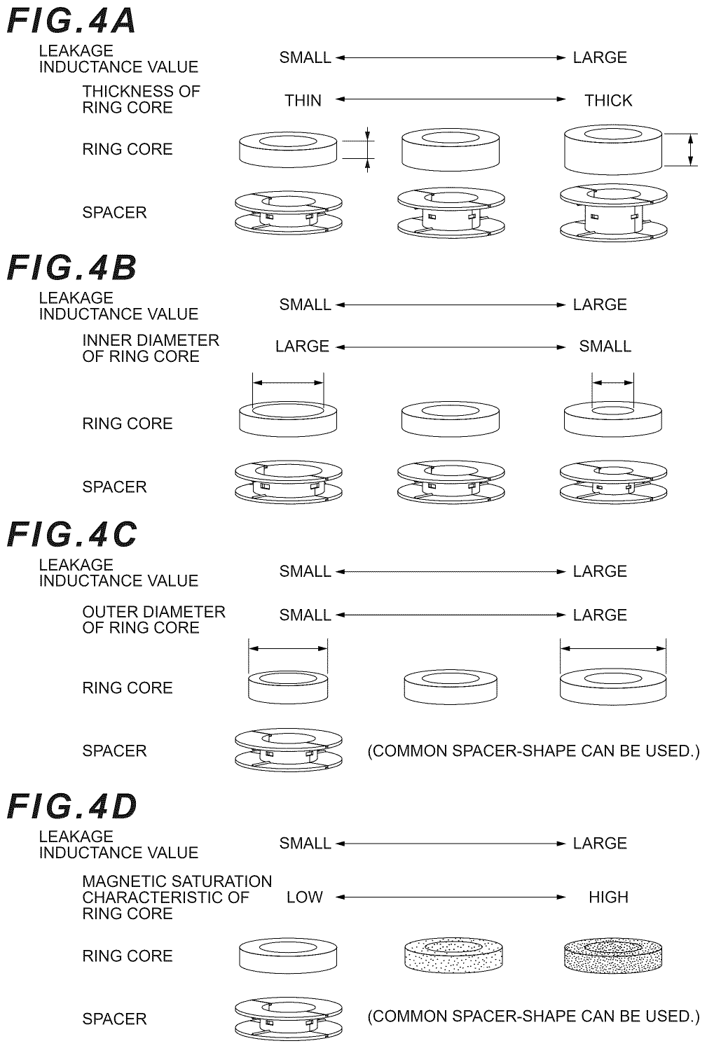

For example, a plurality of types of third cores 3 with mutually different thicknesses (widths) are prepared as illustrated in FIG. 4A, and a third core 3 with which a desired leakage inductance value can be obtained is attached to the ring core placement groove portion 5C. This is based on the fact that the amount of the magnetic fluxes 8 to be branched in the direction of the third core 3 as illustrated in FIG. 3, that is, the amount of leakage inductance increases as the thickness (width) of the third core 3 increases. Note that it is desirable to exchange the spacer member 5 with a spacer member 5 in which the ring core placement groove portion 5C has a width corresponding to the thickness depending on the thickness (width) of the selected third core 3 in terms of holding stability of the third core 3.

Also, a plurality of types of third cores 3 with the same outer diameter and mutually different inner diameters are prepared as illustrated in FIG. 4B, and a third core 3 with which a desired leakage inductance value is obtained is attached to the ring core placement groove portion 5C. This is based on the fact that the amount of leakage inductance in the direction of the third core 3 as illustrated in FIG. 3 increases as the element thickness (a difference between the outer diameter and the inner diameter) of the third core 3 increases. Note that it is desirable to exchange the spacer member 5 with a spacer member 5 in which the ring core placement groove portion 5C has an outer diameter corresponding to the inner diameter of the third core 3 depending on the inner diameter of the selected third core 3 in terms of holding stability of the third core 3.

Also, a plurality of types of third cores 3 with the same inner diameter and mutually different outer diameters are prepared as illustrated in FIG. 4C, and a third core 3 with which a desired leakage inductance value is obtained is attached to the ring core placement groove portion 5C. This is based on the fact that the amount of leakage inductance in the direction of the third core 3 as illustrated in FIG. 3 increases as the element thickness (the difference between the outer diameter and the inner diameter) of the third core 3 increases similarly to the case in FIG. 4B. Note that since the inner diameter can be the same regardless of which of the third cores 3 is selected, a common spacer member 5 may be used.

Furthermore, a plurality of types of third cores 3 with mutually different magnetic saturation characteristics are prepared as illustrated in FIG. 4D, and a third core 3 with which a desired leakage inductance value is obtained is attached to the ring core placement groove portion 5C. This is based on the fact that the amount of leakage inductance in the direction of the third core 3 as illustrated in FIG. 3 increases as the magnetic saturation characteristic of the third core 3 is higher. Note that since the shape can be the same regardless of which of the third cores 3 is selected, a common spacer member 5 may be used.

According to the magnetically coupled inductor 100 in the embodiment, the plurality of third cores 3 with different leakage inductance values are prepared in advance, the third core 3 with which a desired leakage inductance value is obtained is placed on the spacer member 5 attached to the outer circumferential surface of the winding shaft portion 42 of the bobbin 4, it is thus not necessary to change the length of the winding shaft portion 42 in the axial direction according to a change in thickness of the third core 3 as in the aforementioned related art (Patent Literature 1), and it is not necessary to change the interval between the terminal pins 9 of both the terminal blocks 41A and 41B according to a change in the third core 3.

This facilitates securing of the dimensional accuracy of the interval between the terminal pins 9 of both the terminal blocks 41A and 41B and rigidity of the winding shaft portion 42 of the bobbin 4 when the leakage inductance value is adjusted.

Next, a flow of a method of assembling the magnetically coupled inductor according to the embodiment will be described using FIGS. 5A to 8.

First, the bobbin 4 as illustrated in FIG. 5A is produced.

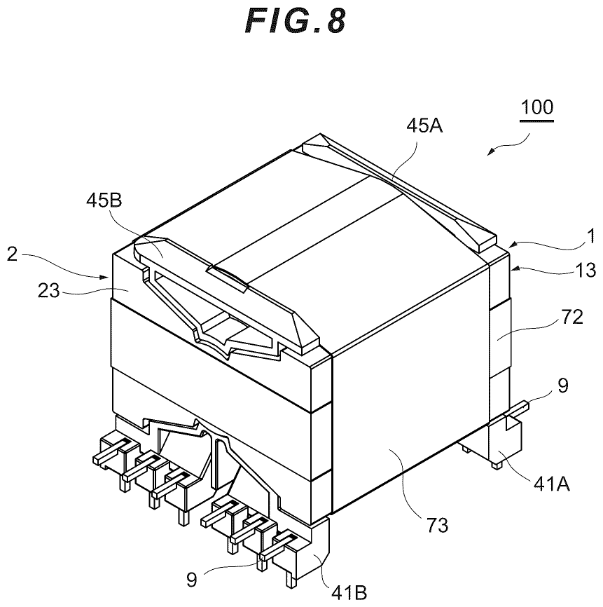

As described above, the bobbin 4 is made of an insulating resin and is produced by molding. The winding shaft portion 42 around which the coil windings 6A and 6B are wound has a cylindrical shape including the hollow portion 42C, and both ends of the winding shaft portion 42 are provided with the flange portions 43A and 43B with substantially disc shapes. Furthermore, the terminal blocks 41A and 41B are provided below the flange portions 43A and 43B, tape suspension portions 45A and 45B for suspending an exterior tape 73 (see FIG. 8) are provided above the flange portions 43A and 43B, and six terminal pins 9 and 9 made of metal are disposed in each of the terminal blocks 41A and 41B in an aligned manner to face lateral sides and a lower side.

Also, four engagement protrusions 44a are provided at every 90 degrees in the circumferential direction of the outer circumferential surface of the winding shaft portion 42 of the bobbin 4 at substantially the center positions in the axial direction in the outer circumferential surface as described above. The engagement protrusions have rectangular parallelepiped shapes that are thin and long in the circumferential direction and have shapes that allow complete engagement with the engagement holes 5Ca (see FIGS. 9A and 9B) of the spacer member 5.

Next, the spacer member 5 is attached to the outer circumferential surface of the winding shaft portion 42 of the bobbin 4 as illustrated in FIG. 5B. The spacer member 5 is configured of the two semiannular portions 51 and 52 as illustrated in FIG. 9B, the semiannular portion 51 is made to approach the winding shaft portion 42 of the bobbin 4 from the upper side, the semiannular portion 52 is made to approach the winding shaft portion 42 from the lower side, and the semiannular portions 51 and 52 are attached to the winding shaft portion 42 such that the engagement holes 5Ca drilled in the semiannular portions 51 and 52 are engaged with the engagement protrusions 44a installed on the outer circumferential surface of the winding shaft portion 42. Then, the semiannular portions 51 and 52 are assembled into an annular shape as illustrated in FIG. 9A in a state where the semiannular portions 51 and 52 are attached to the winding shaft portion 42. The spacer member 5 assembled into the annular shape includes the cylindrical-shaped ring core placement groove portion 5C on which the third core 3 is placed and the spacer flange portions 5A and 5B disposed on both sides of the ring core placement groove portion 5C to stably hold the side surface of the third core 3 as illustrated in FIG. 5B. Therefore, the width of the ring core placement groove portion 5C is set to a size corresponding to the thickness (width) of the third core 3 to be placed.

Note that in FIGS. 9A and 9B, the part of the spacer flange portion 5A on the side of the semiannular portion 51 will be referred to as a spacer flange portion 5A1 while the part of the spacer flange portion 5A on the side of the semiannular portion 52 will be referred to as a spacer flange portion 5A2, the part of the flange portion 5B on the side of the semiannular portion 51 will be referred to as a flange portion 5B1 while the part of the flange portion 5B on the side of the semiannular portion 52 will be referred to as a flange portion 5B2, and furthermore, the part of the ring core placement groove portion 5C on the side of the semiannular portion 51 will be referred to as a ring core placement groove portion 5C1 while the part of the ring core placement groove portion 5C on the side of the semiannular portion 52 will be referred to as a ring core placement groove portion 5C2, from the viewpoint that the spacer member 5 includes the two semiannular portions 51 and 52.

Also, the two semiannular portions 51 and 52 of the spacer member 5 include spacer assembly engagement portions 51A, 51B, 52A, and 52B that are engaged and integrated with each other in a state where the semiannular portions 51 and 52 are attached to the outer circumferential surface of the bobbin 4.

The spacer assembly engagement portion 51A and the spacer assembly engagement portion 52B have the same shape, and inner parts of both the spacer flange portions 5A1 and 5B1 of one end portion (spacer assembly engagement portion 51A) of the semiannular portion 51 and inner parts of both the spacer flange portions 5A2 and 5B2 of the other end portion (spacer assembly engagement portion 52B) of the semiannular portion 52 are notched. On the other hand, the spacer assembly engagement portion 51B and the spacer assembly engagement portion 52A have the same shape, and outer parts of both the spacer flange portions 5A1 and 5B1 of the other end portion (spacer assembly engagement portion 51B) of the semiannular portion 51 and outer parts of both the spacer flange portions 5A2 and 5B2 of one end portion (spacer assembly engagement portion 52A) of the semiannular portion 52 are notched.

In this manner, the spacer assembly engagement portion 51A and the spacer assembly engagement portion 52A are fitted to each other while the spacer assembly engagement portion 51B and the spacer assembly engagement portion 52B are fitted to each other in a state where the two semiannular portions 51 and 52 are assembled as in FIG. 9A.

Furthermore, engagement recessed portions (only an engagement recessed portion on one side of the spacer assembly engagement portion 52B is illustrated in FIG. 9B) 51Q and 52Q (51Q is not illustrated) extending in a radial direction are formed on surfaces facing inward of the spacer assembly engagement portions 51A and 52B at the notched spacer flange portions 5A1, 5B1, 5A2, and 5B2, and engagement projecting portions (only engagement projecting portions on one side of the spacer assembly engagement portions 51B and 52A are illustrated in FIG. 9B) 51P and 52P extending in the radial direction are formed on the surfaces facing outward of the spacer assembly engagement portions 51B and 52A at the notched spacer flange portions 5A1, 5B1, 5A2, and 5B2. Also, the engagement recessed portions 510 and 520 (51Q is not illustrated) and the engagement projecting portions 51P and 52P corresponding to each other are engaged when the spacer assembly engagement portion 51A and the spacer assembly engagement portion 52A are fitted to each other, and the spacer assembly engagement portion 51B and the spacer assembly engagement portion 52B are fitted to each other, such that the two semiannular portions 51 and 52 of the spacer member 5 are stably engaged with this configuration.

Since the spacer member 5 is made of a resin, the part of the spacer flange portions 5A1, 5B1, 5A2, and 5B2 where the engagement recessed portions 510 and 52Q (51Q is not illustrated) and the engagement projecting portions 51P and 52P are formed in the spacer assembly engagement portions 51A, 51B, 52A, and 52B have thin shapes, the parts are easily elastically deformed, and it is thus possible to easily perform an engagement operation between the engagement recessed portions 510 and 52Q (51Q is not illustrated) and the engagement projecting portions 51P and 52P.

Next, the inner circumferential surfaces of the semiannular-shaped ring cores 3A and 3B of the third core 3 are fitted to follow the outer circumferential surface of the ring core placement groove portion 5C of the spacer member 5 attached to the outer circumferential surface of the winding shaft portion 42 of the bobbin 4 as described above, and the semiannular-shaped ring cores 3A and 3B are placed on the ring core placement groove portion 5C as illustrated in FIG. 6A.

Furthermore, the ring core fixation tape 71 is wound around the outer circumferential surfaces of the semiannular-shaped ring cores 3A and 3B such that the semiannular-shaped ring cores 3A and 3B of the third core 3 are held with respect to the spacer member 5 as illustrated in FIG. 6B.

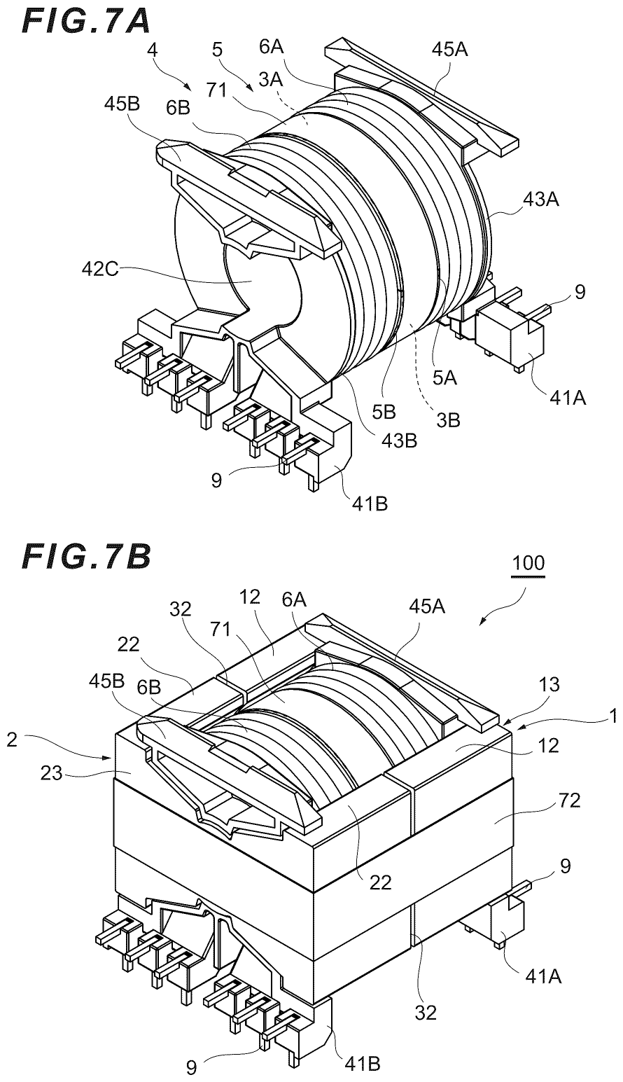

Next, the first coil winding 6A and the second coil winding 6B are wound substantially the same number of times around the winding shaft regions 42A and 42B of the winding shaft portion 42 split by the spacer member 5 as illustrated in FIG. 7A.

Next, the intermediate leg portion 11 of the first core 1 is inserted from the one end side and the intermediate leg portion 21 of the second core 2 is inserted from the other end side into the hollow portion 42C of the tubular-shaped winding shaft portion 42 of the bobbin 4 as illustrated in FIG. 7B.

In this manner, the first core 1 and the second core 2 are disposed such that the corresponding intermediate leg portions 11 and 21 and the outer leg portions 12, 12, 22, and 22 on both sides abut each other. Also, these are disposed such that the gaps 31, 32, and 32 of the predetermined intervals are provided between the corresponding leg portions.

Note that the bobbin 4 and the cores 1 to 3 are integrally fixed by the core fixation tape 72 being wound such that the core fixation tape 72 turns around the circumferential surfaces of lateral portions of the first core 1 and the second core 2. Note that as means for physical integrating the bobbin 4 and the cores 1 to 3, an adhesive, a fastening tool, or the like may be used instead of the core fixation tape 72.

Note that the first coil winding 6A and the second coil winding 6B are configured to be wound up to positions that are substantially equal to the outer circumferential positions of the flange portions 5A and 5B of the spacer member 5 as illustrated in FIG. 7B. In this case, since the outer circumferential positions of the winding of the coil windings 6A and 6B are adjusted in consideration of both the wire diameters and the number of times of winding of the coil windings 6A and 6B, it is possible to balance magnetic fluxes and heat generation generated by the coil windings 6A and 6B (it is possible to further reduce the amount of heat generation as the wire diameter increases).

Also, the outermost circumferential portions of both the flange portions 43A and 43B of the bobbin 4 and the outermost circumferential portions of both the flange portions 5A and 5B of the spacer member 5 are set to have heights with which the outermost circumferential portions are in the vicinity of each other as illustrated in FIG. 7A. It is thus possible to align upward part projecting heights in an upper opened region surrounded by the first core 1 and the second core 2 illustrated in FIG. 7B, it is possible to smoothly perform a winding operation of the exterior tape 73 illustrated in FIG. 8 and to secure integration of a product.

Next, the bobbin 4 and the cores 1 to 3 are more firmly fixed by winding the exterior tape 73 in a direction perpendicularly intersecting the core fixation tape 72 such that the coil windings 6A and 6B are not exposed to outside as illustrated in FIG. 8.

Also, a process of setting the leakage inductance value to a desired value in the aforementioned assembly process is performed by placing the third core 3 selected by using any of the methods in FIGS. 4A to 4D described above on the ring core placement groove portion 5C of the spacer member 5 and fixing the third core 3 thereto in FIG. 6A.

In other words, this process is performed by selecting a desired third core 3 by selecting the thickness (width) of the third core 3 (see FIG. 4A), selecting the inner diameter of the third core 3 (without changing the outer diameter) (see FIG. 4B), selecting the outer diameter of the third core 3 (without changing the inner diameter) (see FIG. 4C), or selecting the magnetic saturation characteristic of the third core 3 (see FIG. 4D) and attaching the selected third core 3 to the spacer member 5. Note that it is also possible to use these plurality of methods in combination.

However, since the magnetically coupled inductor with the core portions in the shape of two adjacent rectangles in plan view is configured by placing the third core 3 on the spacer member 5 as described above in the embodiment, it is important to attach the spacer member 5 including the ring core placement groove portion 5C with a width depending on the thickness of the third core 3 to the winding shaft portion 42 in the case where the method illustrated in FIG. 4A is used, and it is important to attach the spacer member 5 including the ring core placement groove portion 5C with an outer diameter that matches the inner diameter of the third core 3 to the winding shaft portion 42 in the case where the method illustrated in FIG. 4B is used.

The magnetically coupled inductor and the method of assembling the magnetically coupled inductor according to the present invention are not limited to those in the above embodiment and can be changed to other various aspects.

For example, although the PQ cores are used as the first core 1 and the second core 2 in the above embodiment, it is possible to use cores in various forms, such as EE cores and EER cores, instead of the PQ cores.

Moreover, the cores in the various forms, such as EE cores and EER cores, can also be configured by combining a plurality of I core members or columnar core members.

Also, although a method of setting any elements from among the thickness of the third core 3, the inner diameter of the third core 3, the outer diameter of the third core 3, and the magnetic saturation characteristic of the third core 3 or a combination thereof to a desired value has been described as a method of setting the leakage inductance value to a desired value in the above embodiment, it is also possible to use a method of setting a shape element of the third core 3 or a material characteristic element of the third core 3 other than the above elements to a desired value.

Moreover, similar effects are obtained if the winding directions of the coil windings 6A and 6B and the directions of the currents flowing through the coil windings 6A and 6B are adjusted such that all the flowing directions (the directions of the arrows) are opposite in the flows of the magnetic fluxes illustrated in FIG. 3 in the above embodiment.

Furthermore, the shape of the bobbin 4 is also not limited to the shape in the above embodiment and can be another form, and for example, it is possible to change the shape by forming engagement holes instead of the engagement protrusions 44a installed on the outer circumferential surface of the winding shaft portion 42 and forming engagement protrusions to be engaged with the engagement holes of the winding shaft portion instead of the engagement holes 5Ca on the inner circumferential surface of the ring core placement groove portion 5C of the spacer member 5.

In addition, although round wires are used as the coil windings 6A and 6B in the above embodiment, the coil windings 6A and 6B are not limited thereto, other windings may be used, and windings obtained by edge coil winding of flat wires, for example, are not excluded.

Although the third core 3 is split into two parts in the above embodiment, it is also possible to split the third core 3 into three or more parts.

Moreover, although the spacer member 5 is configured of the two semiannular portions 51 and 52 in the above embodiment, it is also possible to configure the spacer member 5 from three or more partial annular portions. However, it is important to form engagement portions (engagement holes, engagement protrusions, and the like) for attachment to the winding shaft portion 42 for each partial annular portion.

Also, although the engagement recessed portions 51Q and 52Q (51Q is not illustrated) are formed in the spacer assembly engagement portions 51A and 52B and the engagement projecting portions 51P and 52P are formed in the spacer assembly engagement portions 51B and 52A in the above embodiment, it is also possible to form the engagement recessed portions 51P and 52P and the engagement projecting portions 510 and 52Q at interchanged positions.

Furthermore, although the process of selecting the third core 3 and attaching the third core 3 to the spacer member 5 is performed prior to the process of winding the coil windings 6A and 6B around the winding shaft portion 42 in the assembling method in the above embodiment, the order may be changed, or the process of winding the coil windings 6A and 6B may be performed in the middle of the process of selecting and attaching the third core 3.

### REFERENCE SIGNS LIST

1, 101 first core
2, 101′ second core
3, 102 third core (ring core)
3A, 3B semiannular-shaped ring core
4, 110, 110′ bobbin
5 spacer member
5A, 5B, 5A1, 5A2, 5B1, 5B2 spacer flange portion
5C, 5C1, 5C2 ring core placement groove portion
5Ca engagement hole
6A first coil winding
6B second coil winding
8 magnetic flux
9, 115, 115′ terminal pin
11, 21 intermediate leg portion
12, 22 outer leg portion
13, 23 rear surface portion
31, 32, 33 gap
41A, 41B terminal block
42, 111, 111′ winding shaft portion
42A, 42B winding shaft region
42C hollow portion
43A, 43B, 112, 112′ flange portion
44a engagement protrusion
45A, 45B tape suspension portion
51, 52 semiannular portion
51A, 51B, 52A, 52B space assembly engagement portion
51P, 52P engagement projecting portion
52Q (51Q) engagement recessed portion
71 ring core fixation tape
72 core fixation tape
73 exterior tape
100 magnetically coupled inductor

1.-12. (canceled)

13. A magnetically coupled inductor comprising:
a first magnetic core and a second magnetic core, each of which includes an intermediate leg portion, outer leg portions located on both sides of the intermediate leg portion, and a rear surface portion that connects the intermediate leg portion and the outer leg portions, the first magnetic core and the second magnetic core being disposed such that distal ends of the intermediate leg portions and distal ends of the outer leg portions are made to abut each other;
a bobbin, into which the intermediate leg portions of the first magnetic core and the second magnetic core are inserted, the bobbin being disposed outside the intermediate leg portions of the two magnetic cores;
an annular-shaped spacer member that is attached in a split manner in a circumferential direction of a winding shaft portion of the bobbin into which the intermediate leg portions are inserted, the annular-shaped spacer member being configured of a cylindrical portion on which an annular-shaped third magnetic core is placed and flange portions disposed at both ends of the cylindrical portion; and
a first coil winding that is wound around one of regions of the winding shaft portion in the axial direction split by the spacer member and a second coil winding that is wound around the other region,
wherein the third magnetic core is attached to an outer periphery of the cylindrical portion of the spacer member in a split manner in the circumferential direction in a state where at least one element from among a shape of the third magnetic core and a material characteristic of the third magnetic core is set to a predetermined size to lead to a desired leakage inductance value depending on a positional relationship between the first magnetic core and the second magnetic core.

14. The magnetically coupled inductor according to claim 13, wherein the at least one element is a thickness of the third magnetic core.

15. The magnetically coupled inductor according to claim 14, wherein a width of the cylindrical portion of the spacer member is adjusted to a size depending on the thickness of the third magnetic core.

16. The magnetically coupled inductor according to claim 13, wherein the at least one element is an inner diameter of the third magnetic core.

17. The magnetically coupled inductor according to claim 16, wherein an outer diameter of the cylindrical portion of the spacer member is adjusted to a size depending on the inner diameter of the third magnetic core.

18. The magnetically coupled inductor according to claim 13, wherein the at least one element is an outer diameter of the third magnetic core.

19. The magnetically coupled inductor according to claim 13, wherein the at least one element is a magnetic saturation characteristic of the third magnetic core.

20. The magnetically coupled inductor according to claim 13, wherein the spacer member is attached to the winding shaft portion by mutually engaging a plurality of first engagement portions aligned in the circumferential direction of an outer circumferential surface of the winding shaft portion and second engagement portions aligned in the circumferential direction of an inner circumferential surface of the cylindrical portion to correspond to the first engagement portions.

21. The magnetically coupled inductor according to claim 13, wherein at least one second engagement portion is provided for each spacer member split in the circumferential direction to correspond to a plurality of first engagement portions aligned in the circumferential direction of an outer circumferential surface of the winding shaft portion.

22. The magnetically coupled inductor according to claim 13, comprising:
spacer assembly engagement portions with which each spacer member split in the circumferential direction is engaged and integrated with each other in a state where the spacer member is attached to the winding shaft portion.

23. The magnetically coupled inductor according to claim 13, wherein outermost circumferential portions of flange portions disposed at both ends of the winding shaft portion of the bobbin are configured to have heights with which the outermost circumferential portions are in a vicinity of outermost circumferential portions disposed at both ends of the cylindrical portion of the spacer member.

24. The magnetically coupled inductor according to claim 13, wherein a fixation tape is wound around an outer circumferential surface of the third magnetic core attached to the outer periphery of the cylindrical portion of the spacer member in a split manner in the circumferential direction.

25. The magnetically coupled inductor according to claim 13, wherein the first magnetic core and the second magnetic core are configured of PQ cores.

26. A method of assembling a magnetically coupled inductor comprising:
a first process of causing distal end portions of intermediate leg portions and distal ends of corresponding outer leg portions of a first magnetic core and a second magnetic core to abut each other, each of the first magnetic core and the second magnetic core including the intermediate leg portion, the outer leg portion located on both sides of the intermediate leg portion, and a rear surface portion connecting the intermediate leg portion and the outer leg portions,
inserting the intermediate leg portions of the first magnetic core and the second magnetic core into a hollow portion of a bobbin, and
attaching an annular-shaped spacer member that is split in a circumferential direction of a winding shaft portion of the bobbin, into which the intermediate leg portion is inserted, in the circumferential direction, the annular-shaped spacer member including a cylindrical portion on which an annular-shaped third magnetic core is placed and flange portions disposed at both ends of the cylindrical portion;
a second process of winding a first coil winding in one of regions split in an axial direction of the winding shaft portion by the spacer member and winding a second coil winding in the other region; and
a third process of setting at least one element from among elements such as a shape of a third magnetic core and a material characteristic of the third magnetic core to a predetermined size to enable a leakage inductance value of the third magnetic core to be set to a desired value, and
attaching the third magnetic core in which the at least one element has been set to the predetermined size to an outer periphery of the cylindrical portion of the spacer member in a split manner in the circumferential direction,
the second process and the third process being performed in a predetermined order after the first process.
